(19) United States
(12) Patent Application Publication
(10) Pub. No.: US 2015/0341531 A1
(43) Pub. Date: Nov. 26, 2015

(54) CAMERA MODULE AND SOLID-STATE IMAGING DEVICE

(71) Applicant: Kabushiki Kaisha Toshiba, Minato-ku (JP)

(72) Inventor: Keiichi SENDA, Kawasaki (JP)

(73) Assignee: Kabushiki Kaisha Toshiba, Minato-ku (JP)

(21) Appl. No.: 14/641,913

(22) Filed: Mar. 9, 2015

(30) Foreign Application Priority Data
May 20, 2014 (JP) 2014-104666

(51) Int. Cl. H04N 5/225; H04N 5/374

(52) U.S. Cl. CPC H04N 5/2253; H04N 5/3741

(57) ABSTRACT

According to embodiments, a camera module has a lens unit, a photoelectric converting section configured to perform photoelectric conversion on light incident through the lens unit and output image data, and a frame composer configured to output frame data obtained by adding vector data calculated from an angular velocity signal to the image data output from the photoelectric converting section.

### CROSS-REFERENCE TO RELATED APPLICATION

This application is based upon and claims the benefit of priority from the prior Japanese Patent Application No. 2014-104666 filed in Japan on May 20, 2014; the entire contents of which are incorporated herein by reference.

### FIELD

Embodiments described herein relate generally to a camera module and a solid-state imaging device.

### BACKGROUND

Conventionally, there have been image stabilization techniques as techniques for improving image quality upon photographing of a still image using a solid-state imaging device.

There are two types of image stabilization methods: an optical type (OIS: optical image stabilization); and an electronic type (EIS: electronic image stabilization). The optical type image stabilization method has a problem that it requires a drive mechanism for operating an optical system, which makes a camera module expensive as well as large.

On the other hand, the conventional electronic type camera shape correction method has a problem that, after an amount of displacement of an image due to camera shake is calculated from two pieces of image data, it is required to perform image synthesis processing for synthesizing a plurality of frame images according to the amount of displacement to generate a single still image, which increases a processing load of an image synthesis circuit such as a central processing unit (CPU).

### BRIEF DESCRIPTION OF THE DRAWINGS

FIG. 1 is a block diagram of a photographing device according to a first embodiment;

FIG. 2 is a schematic configuration diagram showing a configuration of a camera module 3 according to the first embodiment;

FIG. 3 is a block diagram showing a configuration of a solid-state imaging device 16 according to the first embodiment;

FIG. 4 is a diagram showing a data structure of frame data according to the first embodiment;

FIG. 5 is a diagram for explaining a state of an exposure timing at which a mode changes from a viewfinder mode (VFM) to an electronic image stabilization mode (EISM);

FIG. 6 is a diagram for explaining an aspect where divided frames are generated according to a second embodiment; and

FIG. 7 is a diagram showing an example of table data TBL stored in a non-volatile memory 18 according to a third embodiment.

### DETAILED DESCRIPTION

A camera module of an embodiment has an optical system, a photoelectric converting section configured to perform photoelectric conversion on light incident through the optical system and output image data, and a frame data output circuit configured to output frame data obtained by adding motion information calculated from an angular velocity signal to the image data output from the photoelectric converting section.

A solid-state imaging device of an embodiment has a photoelectric converting section configured to perform photoelectric conversion on light incident and output image data, and an exposure controller configured to control the photoelectric converting section to execute image data generation processing to, if motion information calculated from an angular velocity signal exceeds a predetermined value, interrupt exposure of the photoelectric converting section before a first exposure period elapses and generate the image data of an exposure period shorter than the first exposure period, and, if the motion information does not exceed the predetermined value, generate the image data of the first exposure period.

A solid-state imaging device of an embodiment has a photoelectric converting section configured to perform photoelectric conversion on light incident through an optical system and output image data, an angular velocity/vector converter configured to convert an angular velocity signal into vector information, and a vector information correction circuit configured to correct the vector information based on correction information according to the optical system.

### First Embodiment

### Configuration

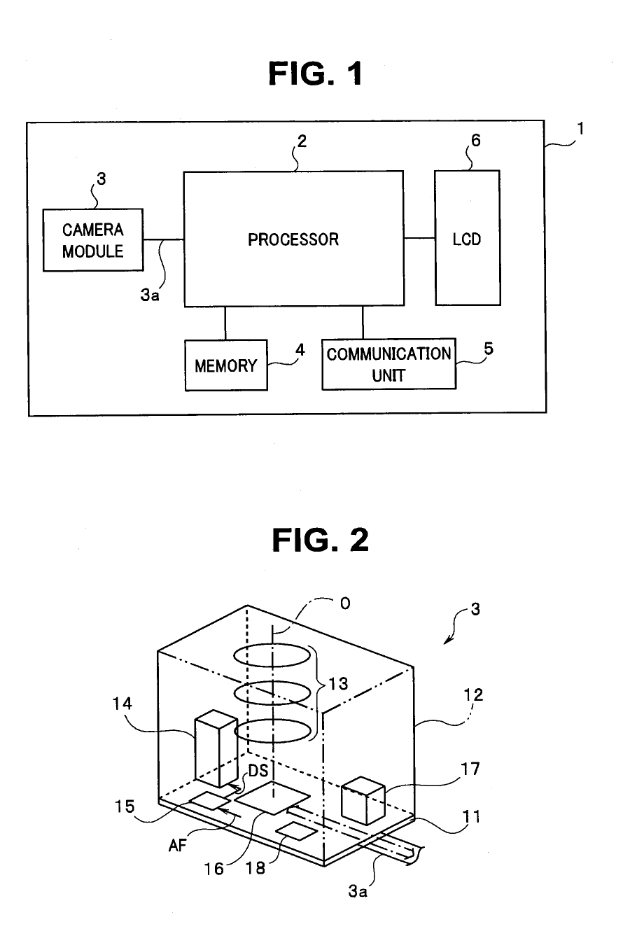

FIG. 1 is a block diagram of a photographing device according to the present embodiment. FIG. 1 shows a configuration of a smartphone 1 as one example of the photographing device. The smartphone 1 has a processor 2, a camera module 3, a memory 4, a communication unit 5 and a liquid crystal display device (hereinafter referred to as an LCD) 6.

The processor 2 which is a control section configured to control the entirety of the smartphone 1 and execute various types of application software, includes a central processing unit (CPU), a ROM and a RAM. A function designated by a user of the smartphone 1 is implemented by the central processing unit (CPU) reading out and executing a program stored in the memory 4. The processor 2 further has an image processing function such as an ISP (image signal processor) configured to process frame data from the camera module 3.

The camera module 3 includes a lens system which will be described later, a solid-state imaging device which is an image pickup element, a gyro sensor, and the like. The camera module 3 is connected to a substrate of the processor 2 via a flexible substrate 3a.

The memory 4 is a storage device configured to store various types of data such as photographed image data, various types of application software, and the like. Here, the memory 4 is a rewritable non-volatile memory.

The communication unit 5 is a circuit configured to perform wireless communication processing for telephone call and transmission and reception of data, which are basic functions of the smartphone 1.

The LCD 6 is a display device in which a touch panel which is not shown is mounted, and a user can select a desired function by touching a screen of the LCD 6 and selecting various functions or various commands.

The smartphone 1 has a camera function as one of the various functions. When the user selects a camera function, a live image is displayed on the LCD 6 by a viewfinder function. When the user depresses a shutter button, for example, touches the shutter button displayed on the LCD 6, while watching the live image, photographing is performed.

FIG. 2 is a schematic configuration diagram showing a configuration of the camera module 3. The camera module 3 which is comprised of a substrate 11, a cover 12 which covers various components mounted on the substrate 11, is disposed within the smartphone 1.

On the substrate 11, a lens unit 13, an actuator 14, an automatic focus driver (hereinafter referred to as an AF driver) 15, a solid-state imaging device 16, a gyro sensor 17 and a non-volatile memory 18 are mounted.

The lens unit 13 which includes a plurality of lenses as objective lenses, is an optical system which can perform focus adjustment. The lens unit 13 forms an image of light incident from an opening portion (not shown) provided at the cover 12 on an image pickup face of the solid-state imaging device 16.

The actuator 14 is a lens drive mechanism configured to drive a lens for focus adjustment located within the lens unit 13 along an optical axis O direction. The actuator 14 is an actuator utilizing, for example, an electromagnet.

The AF driver 15 is a circuit which is connected to the processor 2, the actuator 14 and the non-volatile memory 18, and which is configured to output a drive signal DS for driving the actuator 14 based on an AF driver control signal AF from the processor 2. The AF driver 15 outputs the drive signal DS according to an AF driver control value AFD included in the AF driver control signal to the actuator 14.

The solid-state imaging device 16 is here a CMOS image sensor. A configuration of the solid-state imaging device 16 will be described later.

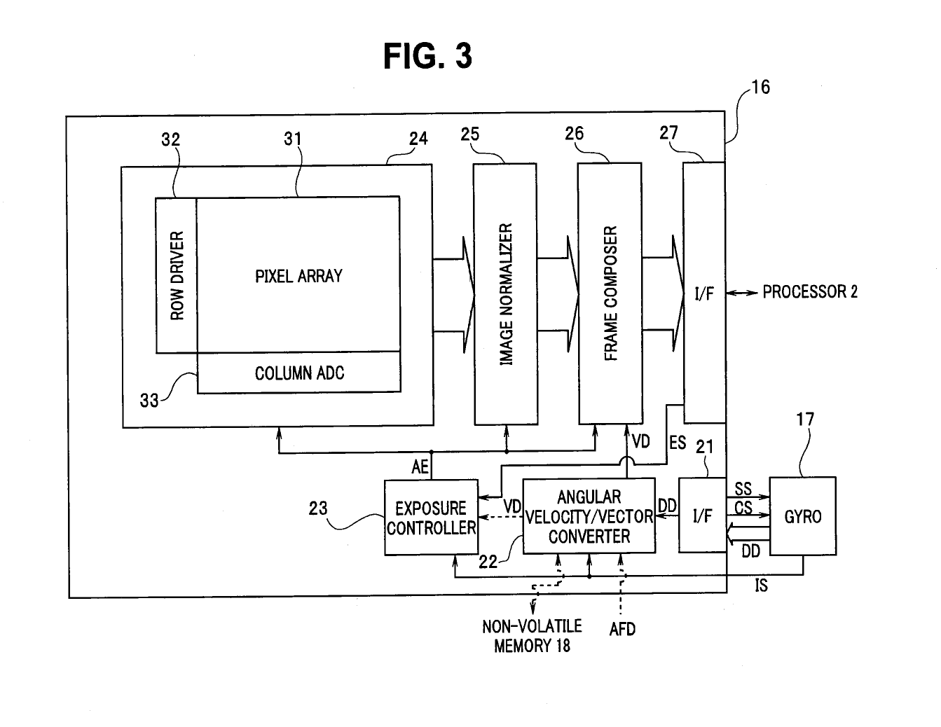

The gyro sensor 17 which is a sensor having two axes of an X axis and a Y axis which are orthogonal to each other, or a sensor having three axes of an X axis, a Y axis and a Z axis, is connected to the solid-state imaging device 16. The gyro sensor 17 outputs an angular velocity signal around each axis to the solid-state imaging device 16. The gyro sensor 17 receives a clock signal SS and a control signal CS which will be described later and outputs an angular velocity signal DD to the solid-state imaging device 16 (see FIG. 3).

The non-volatile memory 18 is a storage device configured to store various types of data. In the non-volatile memory 18, an output value of the drive signal DS corresponding to the AF driver control value AFD included in the driver control signal AF from the processor 2 is stored.

The AF driver 15 reads out the output value of the drive signal DS according to the AF driver control value AFD included in the AF driver control signal AF which is a focus adjustment signal received from the processor 2, from the non-volatile memory 18, and outputs the drive signal DS having the read out output value to the actuator 14.

A plurality of AF driver control values AFD and an output value of a drive signal DS corresponding to each of the AF driver control values AFD are values specific for each camera module, written in the non-volatile memory 18 upon manufacturing of the camera module 3.

FIG. 3 is a block diagram showing a configuration of the solid-state imaging device 16. The solid-state imaging device 16 includes an interface 21 for the gyro sensor 17, an angular velocity/vector converter 22, an exposure controller 23, a photoelectric converting section 24, an image normalizer 25, a frame composer 26 and an interface 27 for image data.

The interface 21 is an interface for outputting a clock signal SS for synchronization and a control signal CS to the gyro sensor 17 and inputting an angular velocity signal DD from the gyro sensor 17.

Further, the gyro sensor 17 is connected to the solid-state imaging device 16 so that an interrupt signal IS from the gyro sensor 17 is supplied to the angular velocity/vector converter 22 and the exposure controller 23 without being through the interface 21.

During a camera mode, the solid-state imaging device 16 supplies the clock signal SS and the control signal CS to the gyro sensor 17 under the control of the exposure controller 23. The clock signal SS and the control signal CS are generated at a circuit which is not shown. The gyro sensor 17 outputs an angular velocity signal DD according to the clock signal SS and the control signal CS. The interrupt signal IS is output when the angular velocity signal DD becomes an abnormal value which is a predetermined value or greater. When receiving the interrupt signal IS, the exposure controller 23 and the angular velocity/vector converter 22 regards the input angular velocity signal DD as a signal of an abnormal value and do not utilize the input angular velocity signal DD.

The angular velocity/vector converter 22 is a circuit configured to sample the angular velocity signal DD at a predetermined sampling rate, and convert the angular velocity signal DD into vector data VD which is trajectory data indicating motion due to camera shake. The angular velocity/vector converter 22 generates vector data VD indicating a direction and an amount of motion in XY space based on the angular velocity signal DD of the gyro sensor 17 of two axes, and outputs the vector data VD to the frame composer 26. That is, the angular velocity/vector converter 22 converts the angular velocity signal DD detected by the gyro sensor 17 into vector data VD which is vector information.

The exposure controller 23 generates automatic exposure control information AE (hereinafter referred to as AE information) including an exposure period and a gain based on the exposure control signal ES from the processor 2 and outputs the AE information to the photoelectric converting section 24. The exposure control signal ES is a signal indicating a target exposure period determined by automatic exposure control at the processor 2.

The exposure controller 23 generates AE information for reading out an image signal using a rolling shutter scheme based on the exposure control signal ES from the processor 2 and outputs the AE information to the photoelectric converting section 24.

The photoelectric converting section 24 is a CMOS image sensor region including a pixel array 31, a row driver 32 configured to drive the pixel array 31, and a column analog digital converter (hereinafter referred to as a column ADC) 33. That is, the photoelectric converting section 24 performs photoelectric conversion on light incident through the lens unit 13 which is an optical system and outputs image data.

The pixel array 31 is a light receiving region in which a plurality of pixels are provided in a matrix. The row driver 32 performs reset and reads out charges accumulated by being exposed after the reset for each row. That is, the charges accumulated by being exposed after the reset are read out for each row by the row driver 32. The read out charge of each column of each row is converted into a digital signal by a column ADC 33 and output to the image normalizer 25. The exposure period of each row is defined by the AE information from the exposure controller 23.

The image normalizer 25 is a circuit configured to output the image data after normalizing brightness of each image data from the photoelectric converting section 24 based on the AE information.

The frame composer 26 is a vector data addition circuit configured to output frame data obtained by adding information such as vector data VD, AE information and a frame count to each image data from the image normalizer 25.

That is, the frame composer 26 is a frame data output circuit configured to output frame data obtained by adding the vector data VD which is motion information calculated from the angular velocity signal DD detected by the gyro sensor 17 to the image data output from the photoelectric converting section 24. The motion information is vector information indicating an amount and a direction of the motion calculated from the angular velocity signal DD detected by the gyro sensor 17.

The vector data VD from the angular velocity/vector converter 22 is data generated from the angular velocity signal DD sampled at a high-speed sampling rate of hundreds to tens of kilohertz, while the frame data is data at a lower output rate than the sampling rate of the vector data VD.

Therefore, for example, vector data to be included in the frame data is vector data V1 which is vector information indicating motion from start of exposure in a first row of the image data until readout of the image data in the first row, and vector data V2 which is vector information indicating motion from start of exposure of the last row until readout of the image data in the last row. These vector data V1 and V2 can be included in each frame data along with information such as AE (automatic exposure) information and a frame count.

The interface 27 outputs the frame data generated at the frame composer 26 to the processor 2.

That is, to the frame data output from the solid-state imaging device 16, the vector data VD which is vector information of an arbitrary period, synchronized with operation of the solid-state imaging device 16 of exposure control is added. For example, as the vector data VD which is the vector information, information V1 indicating motion from completion of readout of the image data in the first row of the previous frame until readout of the image data in the first row of the current frame, or from start of exposure until readout of row data in the first row of the image data of the current frame, and information V2 indicating motion from readout of the previous frame until readout of the current frame of the row data in the last row of the image data, are included.

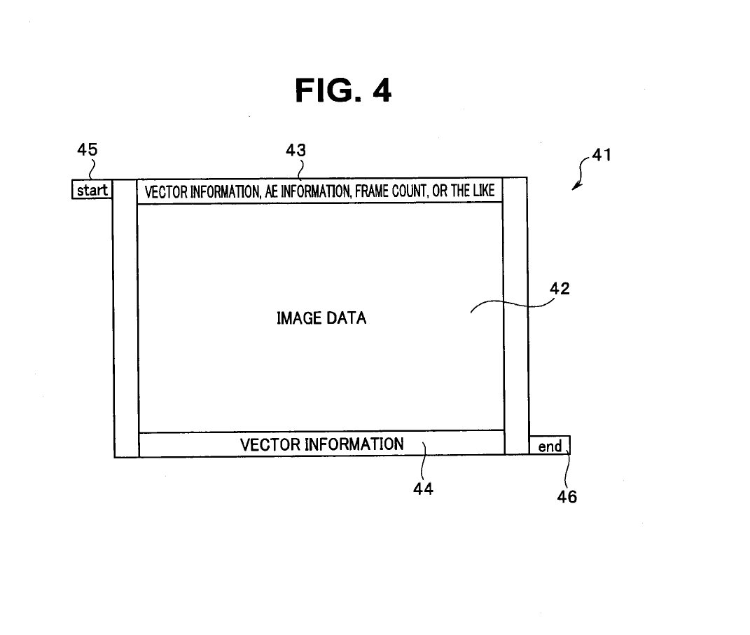

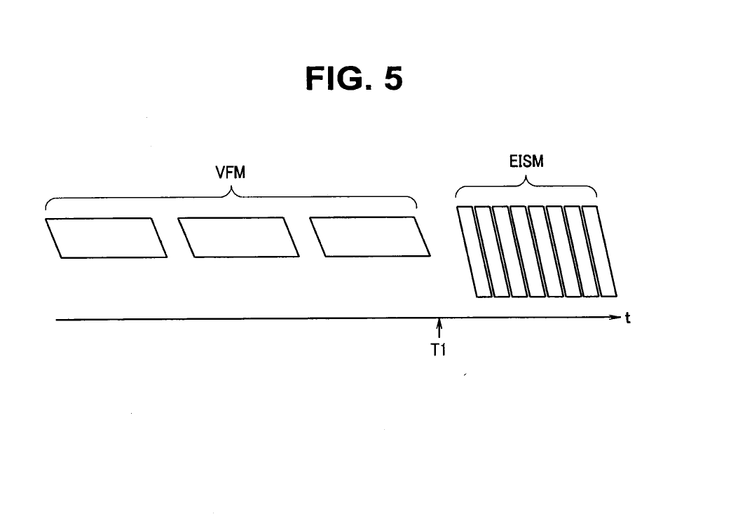

FIG. 4 is a diagram showing a data structure of the frame data. The frame data 41 includes image data 42, addition information 43 added before the image data 42, and addition information 44 added after the image data 42. Further, at the beginning and at the end of the frame data 41, a start bit sequence 45 and an end bit sequence 46 are respectively added.

First, the frame composer 26 adds the addition information 43 including vector information after the start bit sequence 45.

Specifically, when reception of image data in the first row from the image normalizer 25 is started, the frame composer 26 calculates vector data V1 as to motion from, for example, readout of the image data in the first row of the previous frame until readout of the image data in the first row of the current frame, or from start of exposure of the image data in the first row until completion of readout of the image data in the first row based on the AE information from the exposure controller 23 and the vector data VD from the angular velocity/vector converter 22.

The frame composer 26 generates information such as the calculated vector data V1, the AE (automatic exposure) information and the frame count as addition information 43 and adds the information before the image data in the first row.

Note that the AE information is information of an exposure period and a gain determined by the exposure controller 23 based on the exposure control signal ES, and the frame count can be obtained from a frame counter (not shown).

Then, the image data from the second row to the last row is added to the frame data 41.

When reception of the image data in the last row from the image normalizer 25 is started, the frame composer 26 calculates the vector data VD from the angular velocity/vector converter 22 as vector data V2 in which a time difference from readout until readout or from start of exposure until readout in an arbitrary row obtained based on the AE information of the exposure controller 23 is a difference of a travel distance of an imaging screen due to camera shake between frames.

The frame composer 26 adds the information of the calculated vector data V2 after the image data in the last row as addition information 44. The frame composer 26 adds the end bit sequence 46 at the end to generate frame data 41.

The frame data 41 generated as described above is output from the frame composer 26 to the processor 2.

When the smartphone 1 is put into a camera mode, the smartphone 1 is put into a viewfinder mode, and a live view image is displayed at the LCD 6. The processor 2 generates an exposure control signal ES from a brightness value of a pixel included in the obtained image data. The exposure control signal ES is supplied to the exposure controller 23 of the camera module 3.

FIG. 5 is a diagram for explaining a state of an exposure timing at which a mode changes from the view finder mode VFM to an electronic image stabilization mode EISM. A horizontal axis indicates time and a vertical axis indicates a readout timing of the photoelectric converting section 24. When the smartphone 1 is set to the camera mode, the smartphone 1 is put into the viewfinder mode VFM. If the user depresses a shutter button to instruct photographing of a still image, and if EIS operation is turned on, the smartphone 1 is put into the electronic image stabilization mode EISM, and a still image is photographed while the image is stabilized. In FIG. 5, the shutter button is operated at time T1, and the operation mode of the smartphone 1 shifts from the viewfinder mode VFM to the electronic image stabilization mode EISM.

During the electronic image stabilization mode EISM, as described above, the camera module 3 outputs frame data of divided frames including vector data V1 and V2.

### (Advantages)

According to the present embodiment, because the vector data V1 and V2 which are information indicating a direction and an amount of camera shake are included in the frame data 41 to be output from the camera module 3, the processor 2 can perform image synthesis processing based on the vector data V1 and V2 included within the frame data 41, so that it is possible to reduce a load of the image synthesis processing of the processor 2.

Particularly, because the vector information of the image data in the first row and the vector information of the image data in the last row are included in the frame data 41, the processor 2 can also estimate intermediate motion from the first row until the last row from the two pieces of vector information.

Conventionally, a processor which is an image synthesis circuit, had to perform image synthesis after calculating a direction and an amount of camera shake based on an angular velocity signal of the gyro sensor 17, which resulted in a high load of the image synthesis processing. That is, information of the angular velocity signal and information of the image data have been separately input to the processor. However, according to the present embodiment, the processor 2 can acquire image data which is linked with the direction and the amount of camera shake from the frame data. Therefore, because the processor 2 does not have to calculate the direction and the amount of camera shake from the image data, it is possible to reduce a processing load for image synthesis.

Note that in the above-described example, while the two vector data V1 and V2 in the first row and the last row of the image data are included in the frame data 41, it is also possible to configure the frame data 41 so as to include only one of the vector data V1 and V2.

Further, the vector data to be included in the frame data 41 is not limited to the vector data in the first row and the last row and may be vector data in one or more rows between the first row and the last row. In addition, the vector data to be included in the frame data 41 may be the vector data within an arbitrary pixel range within the rows.

It is also possible to enable setting and change of the rows of the vector data to be included in the frame data 41. Further, it is also possible to enable setting and change of the rows of the vector data to be included in the frame data 41 and the pixel range within the rows.

Further, the vector information may be information indicating arbitrary motion points between successive frames or within the same frame. For example, the vector information may be information indicating motion from readout of the row data in the first row of the previous frame until readout of the row data in the first row of the current frame. Further, the vector information may be information indicating motion from readout of the row data in the last row of the previous frame until readout of the row data in the last row of the current frame.

Accordingly, according to the present embodiment, it is possible to realize a camera module and a photographing device which can reduce a processing load of an image synthesis circuit upon electronic image stabilization.

### Second Embodiment

While in the first embodiment, the load of the image synthesis processing of the processor 2 is reduced by configuring the frame data to include vector information so that the processor 2 does not have to calculate the direction and the amount of camera shake from the frame data, in the second embodiment, the load of the image synthesis processing at the processor is reduced by minimizing the number of divided frames to be synthesized.

Because the configurations of the smartphone and the camera module of the present embodiment are the same as those of the first embodiment, explanation of the same components will be omitted by using the same reference numerals, and only different components will be explained.

Note that in the present embodiment, the exposure controller 23 generates AE information based on the vector data VD from the angular velocity/vector converter 22 in addition to the exposure control signal ES from the processor 2 to control the photoelectric converting section 24. Therefore, in FIG. 3, as indicated by the dotted lines, the exposure controller 23 is connected to the angular velocity/vector converter 22 so as to receive input of the vector data VD from the angular velocity/vector converter 22.

During the EIS operation, while a plurality of divided frames are generated and synthesized, it is desired to reduce the number of divided frames to be generated. For example, typically, during the EIS operation, because it is said that synthesis of eight or more divided frames is desirable, it is desired to set the number of divided frames to be eight which is a minimum in order to reduce the processing load of the processor. However, if the number of divided frames becomes small, an exposure period per divided frame becomes long, which may cause a possibility of blurring in the image. That is, if there is blurring in one or more images within a plurality of divided frames before synthesis, image quality during the EIS operation degrades.

Therefore, it is necessary to minimize blurring in an image within each divided frame.

Accordingly, in the present embodiment, the vector data based on the output signal of the gyro sensor 17 is monitored, and, when motion with a predetermined value or greater, that is, the vector data with a predetermined magnitude or larger is detected within a predefined exposure period, the exposure controller 23 controls the photoelectric converting section 24 to interrupt exposure of the divided frame and to start exposure of a new divided frame after the vector data becomes smaller than the predetermined value.

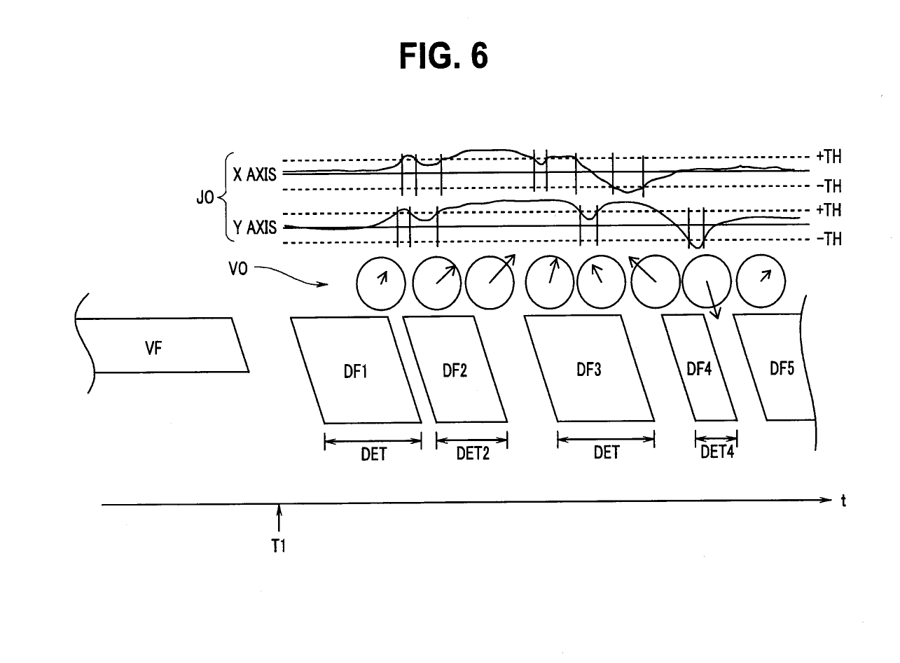

FIG. 6 is a diagram for explaining an aspect of generation of divided frames. A horizontal axis of FIG. 6 indicates time. Output waveforms JO indicate outputs of angular velocities of the X axis and the Y axis. Dotted lines indicate predetermined values TH of the angular velocities. Further, circles VO are figures indicating directions and magnitudes of vector data VD which is an output of the angular velocity/vector converter 22. Radii of the circles VO indicate predetermined values VTH. VF indicates a frame output during the viewfinder mode VFM, and DF1 to DF5 indicate outputs of frames divided through the EIS operation. At time T1, the shutter button is depressed, and the EIS operation for photographing a still image is started. Also at this time, the exposure controller 23 reads out an image signal using a rolling shutter scheme based on the exposure control signal ES from the processor 2.

For example, if the number of division is set at eight, the exposure controller 23 controls the photoelectric converting section 24 to generate and output a divided frame DF1 of a predefined exposure period DET obtained by dividing a target exposure period by eight (the number of division) using an exposure period during the viewfinder mode VFM supplied from the processor 2 as the target exposure period. The target exposure period is included in the exposure control signal ES.

The exposure controller 23 monitors the vector data VD which is an output of the angular velocity/vector converter 22 from start of exposure until readout of the image data in the first row of the divided frame DF1. That is, the exposure controller 23 monitors whether or not the magnitude of the vector data VD which is an output of the angular velocity/vector converter 22 exceeds a predetermined value VTH during outputting of the image data in the first row.

In FIG. 6, in the case of the first divided frame DF1, because the magnitude of the vector data VD which is an output of the angular velocity/vector converter 22 does not exceed the predetermined value VTH during outputting of the image data in the first row, the divided frame DF1 of the predefined exposure period DET is output.

After the divided frame DF1 is output, the exposure controller 23 controls the photoelectric converting section 24 to generate and output a subsequent divided frame DF2.

After generation of the second divided frame DF2 is started, the exposure controller 23 monitors whether or not the magnitude of the vector data VD which is an output of the angular velocity/vector converter 22 exceeds the predetermined value VTH during outputting of the image data in the first row of the second divided frame DF2 as with the case of during outputting of the image data in the first row of the first divided frame DF1.

In the case of FIG. 6, because the magnitude of the vector data VD exceeds the predetermined value VTH during outputting of the image data in the first row of the second divided frame DF2, exposure is interrupted. Therefore, an exposure period DET2 of the divided frame DF2 is shorter than the predefined exposure period DET. Exposure periods for the rows after the second row of the divided frame DF2 are also DET2.

After outputting of the divided frame DF2 for the exposure period DET2 is finished, the exposure controller 23 controls the photoelectric converting section 24 to generate and output a subsequent divided frame DF3.

However, in the case of FIG. 6, because the magnitude of the vector data VD exceeds the predetermined value VTH, the divided frame DF3 is not generated immediately after outputting of the divided frame DF2. The divided frame DF3 is generated after the magnitude of the vector data VD which is an output of the angular velocity/vector converter 22 becomes the predetermined value VTH or smaller.

Also for the divided frame DF3, the exposure controller 23 monitors whether or not the magnitude of the vector data VD which is an output of the angular velocity/vector converter 22 exceeds the predetermined value VTH during outputting of the image data in the first row.

In the case of the third divided frame DF3, because the magnitude of the vector data VD does not exceed the predetermined value VTH during outputting of the image data, exposure is not interrupted and an exposure period of the divided frame DF3 is the same as the predefined exposure period DET. After outputting of the divided frame DF3 is finished, while the exposure controller 23 controls the photoelectric converting section 24 to generate and output a subsequent divided frame DF4, because the magnitude of the vector data VD exceeds the predetermined value VTH, the divided frame DF4 is not generated immediately after outputting of the divided frame DF3.

Then, the magnitude of the vector data VD becomes the predetermined value VTH or smaller, and the divided frame DF4 is generated. In the case of the fourth divided frame DF4, because the magnitude of the vector data VD exceeds the predetermined value VTH during outputting of the image data, exposure is interrupted. Therefore, an exposure period DET4 of the divided frame DF4 is shorter than the predefined exposure period DET.

As described above, divided frames are sequentially generated and output.

If there are divided frames whose exposure periods are shorter than the exposure period DET as the exposure periods DET2 and DET4, the exposure period does not reach the target exposure period, and the image synthesized in the processor 2 does not become an adequately exposed image. Therefore, the exposure controller 23 monitors the total exposure period so as to achieve the target exposure period and controls the photoelectric converting section 24 so that the synthesized image is adequately exposed.

That is, the photoelectric converting section 24 is controlled so as to generate divided frames until the total exposure period of the output divided frames reaches the target exposure period with which the synthesized image is adequately exposed.

For example, when an image whose number of division is eight and whose set exposure period is 500 msec (milliseconds) is generated, the exposure controller 23 controls the photoelectric converting section 24 to generate eight divided frames each exposure period being 62.5 msec.

However, as described above, there is a case where a divided frame may occur, whose exposure period does not reach 62.5 msec as a result of the magnitude of the vector data VD which is an output of the angular velocity/vector converter 22 being the predetermined value VTH or smaller.

The exposure controller 23 controls the photoelectric converting section 24 to calculate the total exposure period, that is, a sum of the exposure periods of the generated and output divided frames and to repeat generation of a divided frame whose exposure period is 62.5 msec until the total exposure period reaches 500 msec.

If the total exposure period is 400 msec at the time point at which eight divided frames are output, the exposure controller 23 continues to control the photoelectric converting section 24 to generate a divided frame whose exposure period is 62.5 msec. When a ninth divided frame whose exposure period is 62.5 msec is generated and output, the exposure controller 23 controls the photoelectric converting section 24 to generate and output a tenth divided frame whose exposure period is 37.5 msec.

Also when the ninth and the tenth divided frames are generated, the exposure controller 23 monitors whether or not the magnitude of the vector data VD exceeds the predetermined value VTH during outputting of the image data in the first row and controls the photoelectric converting section 24 to interrupt exposure when the magnitude of the vector data VD exceeds the predetermined value and generate and output a divided frame with an exposure period at the time of the interruption.

Therefore, if the total exposure period is 400 msec at the time point at which eight divided frames are output, the number of divided frames to be generated thereafter changes according to the magnitude of the vector data VD which is an output of the angular velocity/vector converter 22.

As described above, when the vector data VD which is motion information calculated from the angular velocity signal DD of the gyro sensor 17 exceeds the predetermined value VTH during the EIS operation, the exposure controller 23 interrupts exposure by the photoelectric converting section 24 before the exposure period elapses the set exposure period to generate a divided frame of the image data whose exposure period is smaller than an exposure period determined by automatic exposure control. If the vector data VD does not exceed the predetermined value VTH, the exposure controller 23 controls the photoelectric converting section 24 to execute image data generation processing to generate a divided frame of the image data whose exposure period is the exposure period determined by the automatic exposure control.

Then, the exposure controller 23 controls the photoelectric converting section 24 to repeat execution of the image data generation processing until a total of the exposure periods of a plurality of generated divided frames of the image data reaches the target exposure period.

Note that there is a case where the sufficient number of division cannot be obtained upon photographing with a short exposure period. In such a case, because camera shake is unlikely to occur upon photographing with a short exposure period, the number of division may be made small.

Further, upon photographing with a normal exposure period which is neither a long exposure period nor a short exposure period, EIS operation is executed from one divided by a maximum frame rate of the photoelectric converting section 24 until one divided by a 35 mm equivalent focal length upon photographing.

As described above, according to the present embodiment, during the EIS operation, an exposure period per divided frame is adjusted according to the vector information obtained from the output of the gyro sensor 17. That is, when camera shake is large, the exposure controller 23 controls the photoelectric converting section 24 to generate a divided frame with a short exposure period and so that exposure periods of the output divided frames reach a required total exposure period. That is, the processor 2 which performs image synthesis can generate a synthesized image which is optimally exposed from a minimum number of divided frames, so that it is possible to reduce a load of the image synthesis processing of the processor 2.

Note that the operation of the present embodiment may be combined with the operation of the first embodiment. That is, the solid-state imaging device 16 may output frame data including the vector data VD to the processor 2, and the exposure controller 23 may control the photoelectric converting section 24 to generate and output divided frames until a synthesized image which is optimally exposed is obtained while interrupting generation of divided frames according to the vector data VD. If the present embodiment is combined with the first embodiment, because the processor 2 does not have to calculate the vector data VD from the frame data, and a minimum number of divided frames according to the focal length are synthesized, it is possible to reduce a load of the image synthesis processing.

Therefore, according to the present embodiment, it is possible to realize a camera module and a solid-state imaging device which can reduce a processing load of an image synthesis circuit upon electronic image stabilization.

### Third Embodiment

While in the first embodiment, the load of the image synthesis processing of the processor 2 is reduced by configuring the frame data to include the vector information so that the processor 2 does not have to calculate a direction and an amount of camera shake from the frame data, in the third embodiment, a motion vector on an image is calibrated, particularly, according to a lens position.

In the present embodiment, displacement upon angular velocity/vector conversion in the angular velocity/vector converter 22 is calibrated using calibration data for each product and according to a difference of an AF state, so that motion vector data VD with higher accuracy is output to the processor 2 which executes signal processing in the subsequent stage.

Because the configurations of the smartphone and the camera module of the present embodiment are the same as those of the first embodiment, explanation of the same components are omitted by using the same reference numerals, and only different components will be explained. In the present embodiment, predetermined table data TBL is stored in advance in the non-volatile memory 18.

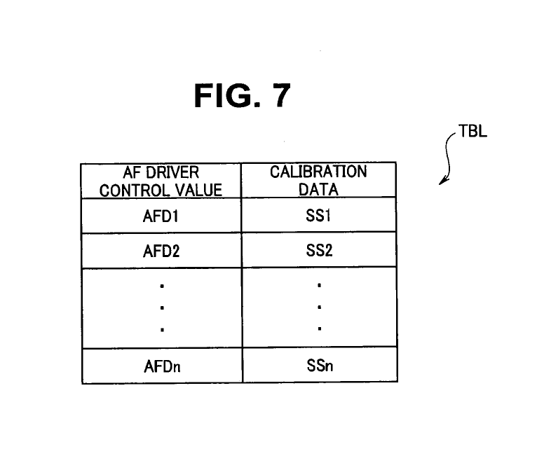

FIG. 7 is a diagram showing an example of the table data TBL stored in the non-volatile memory 18. In the table data TBL, calibration data SS for converting an angular velocity signal into a motion vector, corresponding to an AF driver control value AFD is stored.

The AF driver control value AFD which is a value included in the AF driver control signal AF input to the AF driver 15 for driving the actuator 14 according to a focal length, may take a plurality of values falling within a range from an AF driver control value AFD1 upon macro photographing to an AF driver control value AFDn upon infinite photographing.

As shown in FIG. 7, in the table data TBL, calibration data SS corresponding to the AF driver control value AFD is set in advance such that calibration data SS1 corresponding to the AF driver control value AFD1 is set and calibration data SS2 corresponding to an AF driver control value AFD2 is set. That is, in the table data TBL, information of the calibration data of motion vectors on the image according to information of the position of the lens unit 13 which is an optical system is stored.

As indicated by the dotted lines in FIG. 3, the AF driver control value AFD is input to the angular velocity/vector converter 22 from the AF driver 15 or from an input signal line which leads to the AF driver 15.

Therefore, during the EIS operation, the angular velocity/vector converter 22 acquires calibration data for angular velocity/motion vector conversion, which utilizes a difference of lens positions of the lens unit 13, by referring to the table data TBL in the non-volatile memory 18 based on the AF driver control value AFD. In FIG. 3, as indicated by the dotted lines, the angular velocity/vector converter 22 is connected to the non-volatile memory 18, and can acquire calibration data as correction information for an angular travel distance and a motion vector of the image with reference to the table data TBL. The angular velocity/vector converter 22 performs calibration and outputs how much pixels of a travel distance the obtained angular travel distance corresponds to by utilizing the acquired calibration data.

That is, the angular velocity/vector converter 22 configures a vector information correction circuit that corrects the vector information based on the correction information stored in the non-volatile memory 18. Note that the vector information correction circuit may be included in the exposure controller 23.

As described above, according to the present embodiment, during the EIS operation, because the processor 2 which performs image synthesis can superimpose images based on accurate motion vector information for variation for each camera module, it is possible to reduce the load of the image synthesis processing at the processor 2 and enable accurate superimposition of the images.

The operation of the present embodiment can be combined with the operation of the first embodiment. The frame data output from the camera module 3, including the vector information is output to the processor 2, and the data has been subjected to calibration for variation of products and an AF state. By combining the present embodiment and the first embodiment, the processor 2 does not have to calculate the vector data VD from the image data and can obtain accurate motion vector data, so that it is possible to reduce the load of the image synthesis processing.

Accordingly, according to the present embodiment, it is possible to realize a camera module and a solid-state imaging device which can reduce a processing load of the image synthesis circuit upon electronic image stabilization.

As described above, according to the above-described three embodiments, it is possible to realize a camera module and a solid-state imaging device which can reduce a processing load of the image synthesis circuit upon electronic image stabilization.

Note that while in the above-described three embodiments, a smartphone has been described as an example of the photographing device, the camera module or the solid-state imaging device of each embodiment can be applied to other photographing devices such as a digital camera.

Further, the smartphone 1 which is a photographing device may be configured to have two operation modes of EIS: the operation mode of the second embodiment in which the exposure period is optimized; and the operation mode of the third embodiment in which the number of frames is added, so that the user can select one of the two operation modes and switch the operation modes.

While certain embodiments have been described, these embodiments have been presented by way of example only, and are not intended to limit the scope of the inventions. Indeed, the novel modules and devices described herein may be embodied in a variety of other forms; furthermore, various omissions, substitutions and changes in the form of the modules and devices described herein may be made without departing from the spirit of the inventions. The accompanying claims and their equivalents are intended to cover such forms or modifications as would fall within the scope and spirit of the inventions.

What is claimed is:

1. A camera module comprising:
an optical system;
a photoelectric converting section configured to perform photoelectric conversion on light incident through the optical system and output image data;
and
a frame data output circuit configured to output frame data obtained by adding motion information calculated from an angular velocity signal to the image data output from the photoelectric converting section.

2. The camera module according to claim 1, further comprising a gyro sensor configured to detect the angular velocity signal.

3. The camera module according to claim 2, wherein the motion information is vector information indicating an amount and a direction of motion calculated from the angular velocity signal detected by the gyro sensor.

4. The camera module according to claim 3, further comprising:
an angular velocity/vector converter configured to convert the angular velocity signal detected by the gyro sensor into the vector information.

5. The camera module according to claim 3, wherein the vector information is information indicating arbitrary motion points between successive frames or within a same frame.

6. The camera module according to claim 4, wherein the vector information is first information indicating motion from readout of row data in a first row of a previous frame until readout of row data in a first row of a current frame.

7. The camera module according to claim 6, wherein the vector information further comprises second information indicating motion from readout of row data in a last row of the previous frame until readout of row data in a last row of the current frame.

8. The camera module according to claim 7, wherein
the first information is added immediately after a start bit sequence of the frame data, and
the second information is added immediately before an end bit sequence of the frame data.

9. The camera module according to claim 1, wherein the photoelectric converting section is a CMOS image sensor region.

10. A solid-state imaging device comprising:
a photoelectric converting section configured to perform photoelectric conversion on light incident and output image data; and
an exposure controller configured to control the photoelectric converting section to execute image data generation processing to, if motion information calculated from an angular velocity signal exceeds a predetermined value, interrupt exposure of the photoelectric converting section before a first exposure period elapses and generate the image data of an exposure period shorter than the first exposure period, and, if the motion information does not exceed the predetermined value, generate the image data of the first exposure period.

11. The solid-state imaging device according to claim 10, wherein the exposure controller controls the photoelectric converting section to repeat execution of the image data generation processing until a total of exposure periods of a plurality of pieces of generated image data reaches a second exposure period.

12. The solid-state imaging device according to claim 11, wherein the second exposure period is a target exposure period determined through automatic exposure control.

13. The solid-state imaging device according to claim 10, further comprising:
a frame data output circuit configured to output frame data obtained by adding the motion information to the image data output from the photoelectric converting section.

14. The solid-state imaging device according to claim 13, wherein the angular velocity signal is an output signal of a gyro sensor and the motion information is vector information indicating an amount and a direction of motion calculated from the angular velocity signal.

15. The solid-state imaging device according to claim 14, further comprising:
an angular velocity/vector converter configured to convert the angular velocity signal into the vector information.

16. A solid-state imaging device comprising:
a photoelectric converting section configured to perform photoelectric conversion on light incident through an optical system and output image data;
an angular velocity/vector converter configured to convert an angular velocity signal into vector information; and
a vector information correction circuit configured to correct the vector information based on correction information according to the optical system.

17. The solid-state imaging device according to claim 16, further comprising a memory configured to store the correction information according to information of a lens position of the optical system, wherein
the vector information correction circuit corrects the vector information based on the correction information stored in the memory.

18. The solid-state imaging device according to claim 16, further comprising:
a frame data output circuit configured to output frame data obtained by adding motion information calculated from the angular velocity signal to the image data output from the photoelectric converting section.

19. The solid-state imaging device according to claim 18, wherein the angular velocity signal is an output signal of a gyro sensor and the motion information is vector information indicating an amount and a direction of motion calculated from the angular velocity signal.

20. The solid-state imaging device according to claim 19, further comprising:
an angular velocity/vector converter configured to convert the angular velocity signal into the vector information.
